(19) United States
(12) Patent Application Publication
(10) Pub. No.: US 2016/0313782 A1
(43) Pub. Date: Oct. 27, 2016

(54) METHOD AND SYSTEM OF SHARING A PIN OF A CHIP

(71) Applicant: Shenzhen China Star Optoelectronics Technology Co. Ltd., Guangming New District (CN)

(72) Inventor: Yu WU, Shenzhen, Guangdong (CN)

(21) Appl. No.: 14/654,845

(22) PCT Filed: Apr. 2, 2015
(86) PCT No.: PCT/CN2015/075763

§ 371 Date: Jun. 23, 2015

(51) Int. Cl. G06F 1/32

(52) U.S. Cl. CPC G06F 1/3287

(57) ABSTRACT

A method of sharing a pin of a chip includes receiving a partition type transmitted by the core board after the timing control board enables, setting a status of the idle pin upon enabling based on the partition type after the timing control board enables, detecting the status of the idle pin, and setting a receiving mode of the timing control board as a receiving mode of the corresponding partition of the core board based on the detected status. The function of being compatible with a core board with different partition types is achieved without increasing the area of the timing control board and occupying one of the limited number of pins linking with the interfaces of the timing control board and the core board.

### FIELD OF THE INVENTION

The present invention relates to the technical field of displays, and in particular to a method and a system of sharing a pin of a chip.

### BACKGROUND OF THE INVENTION

Currently, there is a distinction between signals of one partition and signals of two partitions in the ultra-high definition model of ore boards. In order to be compatible with the core board with the different partition types, it is required to add a pin on the timing control board for selecting the corresponding data of one partition or two partitions so that a core board with different partition types can share the same timing control board.

When the core board is in one-partition mode, the control pin is synchronically set to “high”, and the timing control board detects the status of the control pin. When the status of the control pin is detected to be “high”, the receiving mode of the timing control board is set in one-partition mode. When the core board is in two-partition mode, the control pin is synchronically set to “low”, and the timing control board detects the status of the control pin. When the status of the control pin is detected to be “low”, the receiving mode of the timing control board is set in two-partition mode. Thus, this core board and the timing control board correspond to each other.

However, in the above, in order to be compatible with the core board with the different partition types, it is required to add a pin on the timing control board for accordingly controlling the timing control board, which thus increases the area of the timing control board, is disadvantageous to reducing the cost. The added pin also occupies one of the limited number of pins linking with the interfaces of the timing control board and the core board. Therefore, it is necessary to propose a new technical solution to solve the above problems.

### SUMMARY OF THE INVENTION

The purpose of the present invention is to provide a method and a system of sharing a pin of a chip for resolving the problem in which in order to be compatible with the core board with the different partition types, it is required to add a pin on the timing control board for accordingly controlling the timing control board, which thus increases the area of the timing control board, is disadvantageous to reducing the cost, and occupies one of the limited number of pins linking with the interfaces of the timing control board and the core board.

To solve the above problems, the technical solution of the present invention is as follows:

A method of sharing a pin of a chip on a timing control board, for selecting one of various partitions of a core board by using an idle pin on the timing control board upon enabling, the idle pin on the timing control board upon enabling being used as a partition-setting pin, the method comprises steps of:

receiving a partition type transmitted by the core board within a preset time after the timing control board enables;

setting a status of the idle pin upon enabling based on the partition type within the preset time after the timing control board enables;

detecting the status of the idle pin by the timing control board within the preset time after the timing control board enables;

setting a receiving mode of the timing control board as a receiving mode of the corresponding partition of the core board based on the detected status; and recovering original functions of the idle pin upon enabling until the preset time is up.

Preferably, the step of setting a receiving mode of the timing control board as a receiving mode of the corresponding partition of the core board based on the detected status specifically comprises steps of:

setting the receiving mode of the timing control board as the receiving mode of one partition of the core board when the detected status of the idle pin is at high voltage level; and

setting the receiving mode of the timing control board as the receiving mode of two partitions of the core board when the detected status of the idle pin is at low voltage level.

Preferably, the idle pin is a synchronization signal pin of a three-dimension mode.

A method of sharing a pin of a chip on a timing control board, for selecting one of various partitions of a core board by using an idle pin on the timing control board upon enabling, the idle pin on the timing control board upon enabling being used as a partition-setting pin, the method comprises steps of:

receiving a partition type transmitted by the core board after the timing control board enables;

setting a status of the idle pin upon enabling based on the partition type;

detecting the status of the idle pin by the timing control board; and

setting a receiving mode of the timing control board as a receiving mode of the corresponding partition of the core board based on the detected status.

Preferably, the step of receiving a partition type transmitted by the core board after the timing control board enables, specifically comprises the step of:

receiving the partition type transmitted by the core board within a preset time after the timing control board enables;

the step of setting the status of the idle pin upon enabling based on the partition type specifically comprises the step of:

setting the status of the idle pin upon enabling based on the partition type within the preset time after the timing control board enables; and

the step of detecting the status of the idle pin by the timing control board specifically comprises the step of:

detecting the status of the idle pin by the timing control board within the preset time after the timing control board enables.

Preferably, the step of setting a receiving mode of the timing control board as a receiving mode of the corresponding partition of the core board based on the detected status specifically comprises steps of:

setting the receiving mode of the timing control board as the receiving mode of one partition of the core board when the detected status of the idle pin is at high voltage level; and

setting the receiving mode of the timing control board as the receiving mode of two partitions of the core board when the detected status of the idle pin is at low voltage level.

Preferably, after the step of setting a receiving mode of the timing control board as a receiving mode of the corresponding partition of the core board based on the detected status, further comprises the step of:

recovering original functions of the idle pin upon enabling until the preset time is up.

Preferably, the idle pin is a synchronization signal pin of a three-dimension mode.

A system of sharing a pin of a chip on a timing control board, for selecting one of various partitions of a core board by using an idle pin on the timing control board upon enabling, the idle pin on the timing control board upon enabling being used as a partition-setting pin, the system comprises:

a receiving module for receiving a partition type transmitted by the core board after the timing control board enables;

a setting module for setting a status of the idle pin upon enabling based on the partition type;

a detecting module for detecting the status of the idle pin by the timing control board; and

a partition-setting module for setting a receiving mode of the timing control board as a receiving mode of the corresponding partition of the core board based on the detected status.

Preferably, the receiving module is specifically used for receiving the partition type transmitted by the core board within a preset time after the timing control board enables;

the setting module is specifically used for setting the status of the idle pin upon enabling based on the partition type within the preset time after the timing control board enables;

the detecting module is specifically used for detecting the status of the idle pin by the timing control board within the preset time after the timing control board enables.

Preferably, the partition-setting module is specifically used for setting the receiving mode of the timing control board as the receiving mode of one partition of the core board when the detected status of the idle pin is at high voltage level, and for setting the receiving mode of the timing control board as the receiving mode of two partitions of the core board when the detected status of the idle pin is at low voltage level.

Preferably, the system comprises a recovering module for recovering original functions of the idle pin upon enabling until the preset time is up.

Preferably, the idle pin is a synchronization signal pin of a three-dimension mode.

In summary, by sharing the idle pin upon enabling and a partition-setting pin, the embodiment of the present invention achieves the function of being compatible with a core board with different partition types without increasing the area of the timing control board and occupying one of the limited number of pins linking with the interfaces of the timing control board and the core board.

In order to make the above content of the present invention understood easily, preferable embodiments are particularly provided in conjunction with the accompanying drawings below, and described in detail as fallows.

### BRIEF DESCRIPTION OF THE DRAWINGS

FIG. 1 is a schematic flow chart of a method of sharing a pin of a chip provided by an embodiment of the present invention; and

FIG. 2 is a structural diagram of a system of sharing a pin of a chip provided by an embodiment of the present invention.

### DETAILED DESCRIPTION OF THE PREFERRED EMBODIMENTS

The term “embodiment” used in this specification means serving as an example, implementation, or illustration. Furthermore, the article “a or an” used in the specification and the appended claims may generally be construed to mean “one or more” unless it is clearly specified as a singular form otherwise in the context.

In the embodiments of the present invention, by sharing the idle pin upon enabling and a partition-setting pin, it is not necessary to add a pin on the timing control board for accordingly controlling the timing control board, the timing control board is compatible with a core board with different partition types, the cost is reduced, and the limited number of pins linking with the interfaces of the timing control board and the core board are not occupied.

The technical solution of the present invention is illustrated by the following specific embodiments.

In the embodiment of the present invention, a method of sharing a pin of a chip on a timing control board is used for selecting one of various partitions of a core board by using an idle pin on the timing control board upon enabling. The idle pin on the timing control board upon enabling is used as a partition-setting pin.

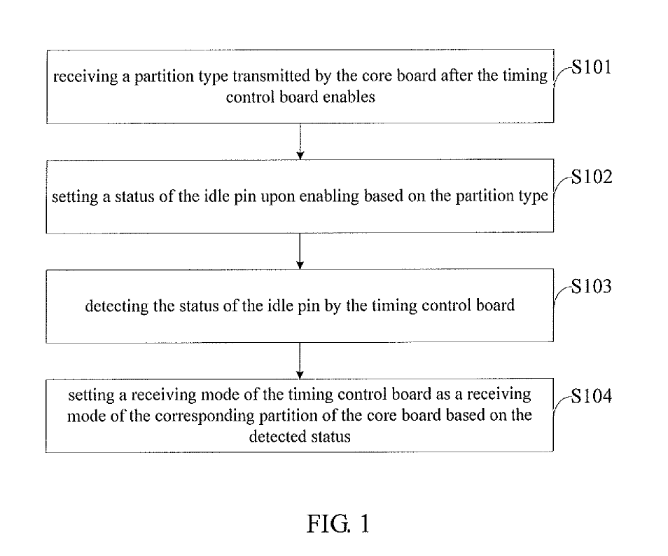

Please refer to FIG. 1, which is a schematic flow chart of a method of sharing a pin of a chip provided by an embodiment of the present invention. The method comprises the following steps:

In step S101, after the timing control board enables, a partition type transmitted by the core board is received.

In this embodiment of the present invention, prior to step S101, the method further comprises the step of presetting the idle pin upon enabling as the partition-setting pin.

In step S102, a status of the idle pin upon enabling is set based on the partition type.

In step S103, the status of the idle pin is detected by the timing control board.

In step S104, a receiving mode of the timing control board is set as a receiving mode of the corresponding partition of the core board based on the detected status.

The implementation process of each step is described in detail as follows:

In step 101, the partition type transmitted by the core board is received within a preset time after the timing control board enables.

In step 102, the status of the idle pin upon enabling based on the partition type within the preset time after the timing control board enables.

In step 103, the status of the idle pin by the timing control board is detected within the preset time after the timing control board enables.

In step 104, the receiving mode of the timing control board is set as the receiving mode of one partition of the core board when the detected status of the idle pin is at a high voltage level; and the receiving mode of the timing control board is set as the receiving mode of two partitions of the core board when the detected status of the idle pin is at a low voltage level.

In the embodiment of the present invention, after step S104, the method further comprises the step of recovering the original functions of the idle pin upon enabling until the preset time is up.

In the following, a synchronization signal pin of a three-dimension mode set as the partition-setting pin is taken as an example to describe the present invention in detail.

The embodiment is used in the models with both a 2-dimension mode and a 3-dimension mode.

In the present embodiment, it is considered that the partition setting is finished at the initialization phase of the timing control board, and once the core board determines the partition, the partition will not be changed during operation. The synchronization signal LR_IN for synchronizing the left eye and right eye images and the glasses in the three-dimension mode only enables in the three-dimension mode, and is idle in the two-dimension mode. In addition, the machine must enable in the two-dimension status, and does not enable in the three-dimension status. Therefore, the three-dimension synchronization signal LR_IN pin and the partition-setting pin are shared in the present embodiment.

The specific working mode is as follows:

The timing control board sets the 3-dimension synchronization signal LR_IN pin as the partition-setting pin within 1 second after enabling. The timing control board detects the high/low status of the 3-dimension synchronization signal LR_IN pin within this 1 second for determining the corresponding partition mode of the core board. For example, when the status of the 3-dimension synchronization signal LR_IN pin is detected to be high, the receiving mode of the timing control board is set to be the one partition mode; when the status of the 3D synchronization signal LR_IN pin is detected to be low, the receiving mode of the timing control board is set to be the two partition mode. The 3-dimension synchronization signal LR_IN pin has to maintain a stable status during the interval.

After this 1 second, the 3-dimension synchronization signal LR_IN pins is set as the synchronization signal working pin LR_IN of the three-dimension mode until the timing control board disables.

However, it can be understood that the timing control board within 1 second after enabling determines the partition mode of the core board. Both the 2-dimension mode and the 3-dimension mode operate in the same partition mode.

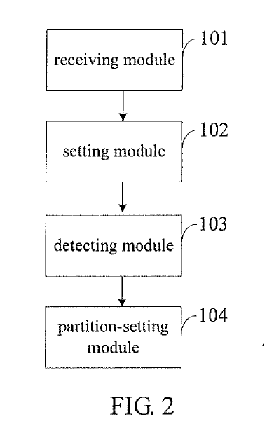

Please refer to FIG. 2, which is a structural diagram of a system of sharing a pin of a chip provided by an embodiment of the present invention. For easy explanation, only the parts related to the embodiment of the present invention are shown. The system of sharing a pin of a chip includes a receiving module 101, a setting module 102, a detecting module 103, and a partition-setting module 104. The system of sharing a pin of a chip may be a software unit, a hardware unit, or a combination of a software unit and a hardware unit.

In this embodiment of the present invention, a system of sharing a pin of a chip on a timing control board is provided by the embodiment of the present invention for selecting one of various partitions of a core board by using an idle pin on the timing control board upon enabling. The idle pin on the timing control board upon enabling is used as a partition-setting pin.

The receiving module 101 is used for receiving a partition type transmitted by the core board after the timing control board enables.

The setting module 102 is used for setting a status of the idle pin upon enabling based on the partition type.

The detecting module 103 is used for detecting the status of the idle pin by the timing control board.

The partition-setting module 104 is used for setting a receiving mode of the timing control board as a receiving mode of the corresponding partition of the core board based on the detected status.

In the embodiment of the present invention, the receiving module 101 is specifically used for receiving the partition type transmitted by the core board within a preset time after the timing control board enables.

The setting module 102 is specifically used for setting the status of the idle pin upon enabling based on the partition type within the preset time after the timing control board enables.

The detecting module 103 is specifically used for detecting the status of the idle pin by the timing control board within the preset time after the timing control board enables.

The partition-setting module 104 is specifically used for setting the receiving mode of the timing control board as the receiving mode of one partition of the core board when the detected status of the idle pin is at high voltage level, and used for setting the receiving mode of the timing control board as the receiving mode of two partitions of the core board when the detected status of the idle pin is at low voltage level.

In an embodiment of the present invention, the system comprises a recovering module for recovering original functions of the idle pin upon enabling until the preset time is up.

In the embodiment of the present invention, the idle pin is a synchronization signal pin of a three-dimension mode, but is not limited to this. All idle pins upon enabling can be used as the partition-setting pin.

In summary, by sharing the idle pin upon enabling and a partition-setting pin, the embodiment of the present invention achieves the function of being compatible with a core board with different partition types without increasing the area of the timing control board and occupying one of the limited number of pins linking with the interfaces of the timing control board and the core board.

The present invention has been described with preferred embodiments thereof and it is understood that various modifications, without departing from the spirit of the present invention, are in accordance with the embodiments of the present invention. Hence, the embodiments described are intended to cover all modifications within the scope and the spirit of the present invention, rather than to limit the present invention.

Although the present invention is described via one or more embodiments, a person of ordinary skill in the art can come up with equivalent variations and modifications based upon the understanding of the present specification and the accompanying drawings. The present invention includes all such modifications and variations, and is only limited by the scope of the appended claims. In particular, as to the various functions performed by the components described above, the terms used to describe the components are intended to correspond to any component performing the specific functions (e.g., which is functionally equivalent) of the components (unless otherwise indicated), even those which are structurally different from the disclosed structure for performing the functions in the exemplary embodiments in the present specification shown herein. In addition, although a particular feature in the present specification is disclosed in only one of many embodiments, this feature may be combined with one or more features in other embodiments which are desirable and advantageous to a given or particular application. Moreover, the terms “include”, “have”, “consist of”, or alterations thereof used in the detailed description or the claims are intended to be used in a manner similar to the term “comprising”.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

In the claims:

1. A method of sharing a pin of a chip on a timing control board, for selecting one of various partitions of a core board by using an idle pin on the timing control board upon enabling, the idle pin on the timing control board upon enabling being used as a partition-setting pin, the method comprises steps of:
receiving a partition type transmitted by the core board within a preset time after the timing control board enables;
setting a status of the idle pin upon enabling based on the partition type within the preset time after the timing control board enables;
detecting the status of the idle pin by the timing control board within the preset time after the timing control board enables;
setting a receiving mode of the timing control board as a receiving mode of the corresponding partition of the core board based on the detected status; and
recovering original functions of the idle pin upon enabling until the preset time is up.

2. The method according to claim 1, wherein the step of setting a receiving mode of the timing control board as a receiving mode of the corresponding partition of the core board based on the detected status, specifically comprises steps of:
setting the receiving mode of the timing control board as the receiving mode of one partition of the core board when the detected status of the idle pin is at high voltage level; and
setting the receiving mode of the timing control board as the receiving mode of two partitions of the core board when the detected status of the idle pin is at low voltage level.

3. The method according to claim 1, wherein the idle pin is a synchronization signal pin of a three-dimension mode.

4. A method of sharing a pin of a chip on a timing control board, for selecting one of various partitions of a core board by using an idle pin on the timing control board upon enabling, the idle pin on the timing control board upon enabling being used as a partition-setting pin, the method comprises steps of:
receiving a partition type transmitted by the core board after the timing control board enables;
setting a status of the idle pin upon enabling based on the partition type;
detecting the status of the idle pin by the timing control board; and
setting a receiving mode of the timing control board as a receiving mode of the corresponding partition of the core board based on the detected status.

5. The method according to claim 4, wherein the step of receiving a partition type transmitted by the core board after the timing control board enables, specifically comprises the step of:
receiving the partition type transmitted by the core board within a preset time after the timing control board enables;
the step of setting the status of the idle pin upon enabling based on the partition type, specifically comprising the step of:
setting the status of the idle pin upon enabling based on the partition type within the preset time after the timing control board enables; and
the step of detecting the status of the idle pin by the timing control board, specifically comprising the step of:
detecting the status of the idle pin by the timing control board within the preset time after the timing control board enables.

6. The method according to claim 4, wherein the step of setting a receiving mode of the timing control board as a receiving mode of the corresponding partition of the core board based on the detected status, specifically comprises steps of:
setting the receiving mode of the timing control board as the receiving mode of one partition of the core board when the detected status of the idle pin is at high voltage level; and
setting the receiving mode of the timing control board as the receiving mode of two partitions of the core board when the detected status of the idle pin is at low voltage level.

7. The method according to claim 4, wherein after the step of setting a receiving mode of the timing control board as a receiving mode of the corresponding partition of the core board based on the detected status, further comprises the step of:
recovering original functions of the idle pin upon enabling until the preset time is up.

8. The method according to claim 4, wherein the idle pin is a synchronization signal pin of a three-dimension mode.

9. A system of sharing a pin of a chip on a timing control board, for selecting one of various partitions of a core board by using an idle pin on the timing control board upon enabling, the idle pin on the timing control board upon enabling being used as a partition-setting pin, the system comprises:
a receiving module for receiving a partition type transmitted by the core board after the timing control board enables;
a setting module for setting a status of the idle pin upon enabling based on the partition type;
a detecting module for detecting the status of the idle pin by the timing control board; and
a partition-setting module for setting a receiving mode of the timing control board as a receiving mode of the corresponding partition of the core board based on the detected status.

10. The system according to claim 9, wherein
the receiving module is specifically used for receiving the partition type transmitted by the core board within a preset time after the timing control board enables;
the setting module is specifically used for setting the status of the idle pin upon enabling based on the partition type within the preset time after the timing control board enables;
the detecting module is specifically used for detecting the status of the idle pin by the timing control board within the preset time after the timing control board enables.

11. The system according to claim 9, wherein the partition-setting module specifically used for setting the receiving mode of the timing control board as the receiving mode of one partition of the core board when the detected status of the idle pin is at a high voltage level; and for setting the receiving mode of the timing control board as the receiving mode of two partitions of the core board when the detected status of the idle pin is at a low voltage level.

12. The system according to claim 9, comprising a recovering module for recovering original functions of the idle pin upon enabling until the preset time is up.

13. The system according to claim 9, wherein the idle pin is a synchronization signal pin of a three-dimension mode.
